(19) United States
(12) Patent Application Publication
(10) Pub. No.: US 2005/0108082 A1
(43) Pub. Date: May 19, 2005

(54) Marketing apparatus and methods

(76) Inventor: David Angus Grant Jenkinson, Huntingdon (GB)

Correspondence Address: STETINA BRUNDA GARRED & BRUCKER, 75 ENTERPRISE, SUITE 250, ALISO VIEJO, CA, 92656, US

(21) Appl. No.: 10/784,579

(22) Filed: Feb. 23, 2004

(30) Foreign Application Priority Data
Oct. 31, 2003 (GB) 0325435.6
Dec. 9, 2003 (GB) 0328489.0

(51) Int. Cl. G06F 17/60

(52) U.S. Cl. 705/10

(57) ABSTRACT

A method for quantifying and communicating marketing-related information relating to an entity, comprising: assigning a score to each of a plurality of pre-determined marketing-related dimensions, each score being out of a pre-determined maximum possible score; and communicating said scores as a characteristic of said entity. Preferably said pre-determined marketing-related dimensions are: idea forming; relationship building; behavior activation; help or support; and product or service or environment experience. Each dimension may be assigned a score out of seven, and the total of the scores may be limited so as not to exceed a pre-determined maximum possible total of 22. The scores are preferably plotted in a radar chart format, and this may be accomplished using pre-printed paper. Also provided is a device for visualizing scores assigned to each of a plurality of marketing-related dimensions, said device comprising: a base element; a plurality of radial arms protruding from the base element, each radial arm corresponding to one of the said marketing-related dimensions; and a marker element on each radial arm, each marker element being positionable in any of a plurality of positions on its radial arm, said positions corresponding to possible scores for the corresponding marketing-related dimension.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

This invention relates to marketing and, in particular, to apparatus and methods for use in planning, communicating and implementing marketing strategies.

The marketing communications industry has a wide variety of different methods and criteria that vary by discipline, media and audience type. The absence of universal or common standards and methods means that marketers and other change agents can neither specify communication objectives nor evaluate results to a common or universal standard. This makes comparison and discussion between the methods difficult and makes it hard or impossible to collate, compare and analyze results across either parallel communication projects or multiple communication projects over time. These difficulties also affect preliminary and post-hoc evaluation research in support of communication projects, particularly when they involve multiple communications types and varied audiences, stakeholders or publics.

Communication managers (“the communicator”) therefore need a tool capable of being adapted to a variety of technical, organizational and social cultures and languages and embodied in a variety of information systems, including data collection and analysis, which enables people to research, plan, design, execute and analyze any communication project or a series of projects that has the intent of influencing attitudes and behavior by using an effective universal or common standards framework. Examples of such projects include single or multi-media projects, single or multi-discipline communications, to an individual or individuals, segments or groups of people in any combination. Examples of media include TV, radio, press, mail, internet banner ads, poster sites and billboards, email, ambient media, SMS, point of sale, shelf and other in-store displays, brochures, corporate magazines and business proposals, quotations and reports, business mail, financial statements, canteens, offices and other employee locations, internal office mail, stores, service areas and other customer locations, vouchers and coupons, customer, employee, press, analyst and other events or parts of an event, sales calls, websites and web pages, product packaging, user manuals, help text, credit and member cards, exhibition stands, product demonstrations, product trials and products. Examples of disciplines include advertising, direct marketing, public relations, lobbying, fundraising, sponsorship, relationship marketing, direct response advertising, sales promotion, personal selling, human resources management, service management, interactive marketing, retail design, events management, media planning, customer employee and stakeholder research, telemarketing, promotions, personal selling, loyalty programs, product design, packaging design, brand management, CSR, as well as integrated marketing, integrated marketing communications (IMC), integrated communication planning (ICP), media neutral planning (MNP), internal marketing, business alignment, for example in the context of mergers and acquisitions, strategic positioning, culture change, corporate governance or business leadership, and consultancy projects such as organization development or transformation. Examples of people, segments and groups of people for whom communication might be designed (“the communicatee”) include: prospective customers, customers, employees, shareholders, financial and other analysts, press, various publics, governmental agencies, decision making units or groups in organizations, industry or society influencers, channel and business partners, and suppliers.

In pursuit of the above objectives, communication managers also need a tool that provides a common standard for discussion, planning, briefing, specification, execution, evaluation, learning and knowledge management phases with a variety of external and internal interested individuals, groups or companies, including, externally, those in fields such as research, branding, design, advertising, direct marketing, sales promotion, PR, events, business and change consultancy, media planning, and, internally, functional sections and departments and process groups within sales, service, marketing, CRM, CSR, corporate reputation and HR.

Furthermore, in pursuance of these requirements, external service companies, consultancies and communication agencies require a tool to enable them to discuss and agree requirements and priorities with clients, to collect data about performance using a variety of user interfaces and then collate data about multiple and various projects over time and across clients.

Finally, in pursuit of the above objectives, communication managers in any organization need to be able to compile one or more databases and workflow systems, accessible by wireless or wired technology and a wide variety of user interfaces, which can collect a variety of information about a multiplicity of local, national or international communication projects in different languages and adapted to various organizational cultures in such a way that there is a meaningful, sound and effective common structure for linking and comparing data in the aforesaid communication projects.

### BRIEF SUMMARY OF THE INVENTION

According to a first aspect of the invention there is provided a method for quantifying and communicating marketing-related information relating to an entity, comprising: assigning a score to each of a plurality of pre-determined marketing-related dimensions, each score being out of a pre-determined maximum possible score; and communicating said scores as a characteristic of said entity.

Preferably said pre-determined marketing-related dimensions are: idea forming; relationship building; behavior activation; help or support; and product or service or environment experience.

Preferably the total of said scores is limited so as not to exceed a pre-determined maximum possible total. Particularly preferably the method comprises five pre-determined dimensions, wherein each dimension is assigned a score out of seven, and wherein the pre-determined maximum possible total is 22.

Preferably the method further comprises representing each of said scores visually. Particularly preferably the scores are plotted in a radar chart format.

In accordance with one embodiment of the invention, the scores may be plotted on paper pre-printed with radial arms labeled with said pre-determined dimensions, the radial arms incorporating marker points indicating positions at which possible scores may be represented.

In accordance with a second embodiment of the invention, the scores may be represented by positioning marker elements on a mechanical device, the mechanical device comprising: a base element; a plurality of radial arms protruding from the base element, each radial arm corresponding to one of the said dimensions; and a marker element on each radial arm, each marker element being positionable in any of a plurality of positions on its radial arm, said positions corresponding to possible scores for the corresponding dimension.

The method may further comprise: assigning planned or target scores to each dimension; and subsequently determining actual scores for each dimension, thereby enabling comparison of the target and actual scores.

Preferably the method further comprises entering the scores into a computer.

Preferably said scores correspond with measurable objectives or achievements for said entity.

The method may be used to retrospectively assign scores to past communication projects and analyze them to calibrate the method.

The method may be performed for a plurality of entities within an overall entity, i.e. from a macro level concept to the micro level detail. It is therefore operable as a fractal tool.

The method may further comprise: identifying touchpoints at which a consumer interacts with the entity's product, service or communication elements; and applying the method to those touchpoints.

The method may further comprise recording data of a type selected from a group comprising: verbal description of the objectives; verbal reasons for the objectives; one or more numerical or quantitative objectives or one or more weighted objectives that represents full attainment of one or more planned or target scores; actual quantitative achievement(s); final result scores; budget allocations; actual costs; the cost per score point; indices of efficiency against a benchmark database; verbal analysis of the reasons for the result; codification of the reasons using standard codes; learning points.

The method may be adapted for use in an application selected from a group comprising: an audit of customer touchpoints and research into the relative priority given by each type of communicatee to the score dimensions at each touchpoint; what constitutes full satisfaction; research of overall brand and/or product/service experience using the plurality of dimensions; benchmarking against competitive brands/products; pre-testing of communication; post-communication research design; usages and attitudes brand tracking design; library cataloguing of research projects using the plurality of dimensions.

According to a second aspect of the invention there is provided a device for visualizing scores assigned to each of a plurality of marketing-related dimensions, said device comprising: a base element; a plurality of radial arms protruding from the base element, each radial arm corresponding to one of the said marketing-related dimensions; and a marker element on each radial arm, each marker element being positionable in any of a plurality of positions on its radial arm, said positions corresponding to possible scores for the corresponding marketing-related dimension.

Preferably the radial arms are configured with means by which to retain the marker elements in the said plurality of positions.

Particularly preferably the marker elements are connected by a rubber band. The marker elements may be in the form of balls.

According to a third aspect of the invention there is provided a printed article for visualizing scores assigned to each of a plurality of marketing-related dimensions, said article comprising a surface pre-printed with radial arms labeled with said dimensions, the radial arms incorporating marker points indicating positions at which possible scores may be represented.

Preferably the printed article is selected from a group comprising: pre-printed post-it notes; pre-printed paper.

According to a fourth aspect of the invention there is provided apparatus for quantifying and communicating marketing-related information relating to an entity, said apparatus comprising: an input device operable to receive a plurality of scores, each score being out of a pre-determined maximum possible score; a processor operable to assign each score to a corresponding one of a plurality of pre-determined marketing-related dimensions; and an output device operable to communicate said scores as a characteristic of said entity.

Preferably the output device is arranged to display the scores in the form of a radar chart.

According to a fifth aspect of the invention there is provided a computer programmed for use in quantifying and communicating marketing-related information relating to an entity, said computer being programmed to: receive a plurality of scores, each score being out of a pre-determined maximum possible score; assign each score to a corresponding one of a plurality of pre-determined marketing-related dimensions; and output said scores as a characteristic of said entity.

Preferably the computer is further programmed to display the scores in the form of a radar chart.

According to a sixth aspect of the invention there is provided a computer program executable to enable a computer to receive and communicate marketing-related information relating to an entity, said computer program enabling the computer to: receive a plurality of scores, each score being out of a pre-determined maximum possible score; assign each score to a corresponding one of a plurality of pre-determined marketing-related dimensions; and output said scores as a characteristic of said entity.

Preferably the computer program is configured to display the scores in the form of a radar chart.

According to a seventh aspect of the invention there is provided a computer program stored on a data carrier, said computer program being executable to enable a computer to receive and communicate marketing-related information relating to an entity, said computer program enabling the computer to: receive a plurality of scores, each score being out of a pre-determined maximum possible score; assign each score to a corresponding one of a plurality of pre-determined marketing-related dimensions; and output said scores as a characteristic of said entity.

### BRIEF DESCRIPTION OF THE DRAWINGS

Embodiments of the invention will now be described, by way of example, and with reference to the drawings in which:

FIG. 1 illustrates the scope of the tool in accordance with an embodiment of the invention, and how it can be used for planning across the value-mix;

FIG. 2 illustrates the use of the tool in strategic value positioning;

FIG. 3 illustrates the use of the tool in fractal applications and planning;

FIG. 4a illustrates planning by touchpoint;

FIG. 4b illustrates planning by relationship stage;

FIG. 5a illustrates prioritization, planning and reporting using the radar visual;

FIG. 5b shows examples of planning tools;

FIG. 6 illustrates complete project planning, incorporating a rollout plan differentiating time, media and contact objectives for each customer community;

FIG. 7 illustrates an example of a planning process;

FIG. 8a shows how an agency can use embodiments of the invention;

FIG. 8b shows how a media/discipline planner can use embodiments of the invention;

FIG. 9 depicts the universal engine with the analytics sub-system;

FIG. 10 illustrates the evaluation and learning process; and

FIG. 11 illustrates a technical system schematic.

### DETAILED DESCRIPTION OF THE INVENTION

The detailed description set forth below in connection with the appended drawings is intended as a description of the presently preferred embodiments of the invention, which represent the best ways currently known to the applicant of putting the invention into practice. However they are not the only ways in which this can be achieved, and accordingly the detailed description below is not intended to represent the only form in which the present invention may be utilized or constructed. It is to be understood that the same or equivalent functions to those described may be accomplished by different embodiments that are also intended to be encompassed within the spirit and scope of the invention.

The embodiments of the invention provide a simple prioritization scoring system that is capable of being embodied in a variety of information systems, data collection tools and workflow methods. The entire system is structured around five planning and scoring dimensions, which constitute the common standards prioritization framework. (More than, or fewer than, five planning and scoring dimensions are also possible.) This can be incorporated in a variety of online and offline data collection and planning tools (such as communication briefs) and used to enter data into a communication management system that stores data about communication projects in a database. The database can be accessed and updated, for example with results of projects. A graphic generator may be used to display plans and results in the form of a radar chart or other preferred format.

In a preferred embodiment of the invention, the universal standard for all communication projects consists of five elements. These may be renamed by individual users of the system but the core concepts provide the framework for cross-project and cross-industry planning and evaluation. These five dimensions are:
(1) Idea forming, referring to the communicator's objective of influencing the ideas that the subject of the communication (such as brand) after the communication takes place;
(2) Relationship building, referring to the objective of causing the communicatee to feel themselves connected through some form of relationship with the communicator or some other entity of the communicator's choosing. Examples might be the feeling of affinity or trust or appreciation, the sense of being personally known or supported, knowing who to contact, belonging to some privileged or special group, and others;
(3) Behaviour activation, referring to the objective of causing an intentional or actual behaviour change by the communicatee, for example sales activation, sales enquiry or commitment to behaviour change;
(4) Help or support, referring to the objective of providing required help or support to the communicatee, for example in the form of information about a product or policy or help in a process; and
(5) Product or service or environment experience, referring to the objective of giving the communicates an experience of the subject of the communication, whether actual, such as in a product trial, or virtual, such as through a visual or verbal representation of the subject to assist the imagination and/or memory of the communicatee.

Each of these objectives or dimensions is said to be desirable and normally present in every act of (sales-oriented) communication. However, the relative priority and specific objectives of each element will vary from communication to communication. It is the process of selecting the relative priorities and specific content of these objectives and subsequent evaluation of performance against them that constitutes the core of the invention's process.

The scores assigned to each communication at the planning and evaluation stage represent the communication's signature and each communication can then be compared with any other as to the balance of objectives. Along with these scores, communicators describe the objectives in text and define what performance in units relevant to that communication constitutes that level of performance. It is therefore possible to define a planned score or performance level (‘plan score’) and subsequently calculate the actual score or performance level (‘actual score’).

A typical application might therefore include:
Planning for an overall set of objectives for a new product launch: the brand manager assigns priorities out of (say) 7 to the 5 dimensions such that the total plan score is no more than (say) 22, defining what precisely is achieved in qualitative and quantitative terms to achieve these objectives and by when.
Planning for different components of the overall communication for each audience type using the same method—for example use of TV, website, in-store promotion and trial, and product packaging—is then done with and by various agencies working with the brand manager.
Actual results are later fed into the system and agreed or automatic conversion takes place to give the result scores.
At each stage scores may be displayed numerically and/or graphically and will be associated with textual elucidation.

Applications such as that outlined above can be embodied in a variety of workflow processes and information systems. For example, initial discussions or planning might be purely verbal or a writing surface (such as paper or pre-printed notes) to capture proposed scores either as numbers or graphically. Alternatively users might interface with a standard spreadsheet. However, at some convenient point the data can be entered into software designed to support the standard operational procedure. Once captured, normal IT applications are available. For example, data cannot only be stored but also distributed, for example to sales people (as sales calls objectives), to advertising or other agencies (as marketing communication briefs) or to other staff and managers.

The minimum data required to implement the application is a score against each of the five dimensions. Additional data typically captured against each communication project (in addition to any other data the users wish to capture) would be: verbal description of the objectives, i.e. an elucidation of the plan scores; a verbal reason for this; a numerical or quantitative objective or several weighted objectives, that represents full attainment of each planned score; the methods used; the actual quantitative achievement(s); the final result scores; the budget allocated in whatever categories are appropriate; the actual costs; the cost per score point; indices of efficiency against a benchmark database; verbal analysis of the reasons for the result; codification of the reasons using standard codes; any learning points.

Each communication project can support a hierarchy of specific communication sub-projects based on types of people, media, discipline and time. By allocating score and performance equivalents for each element within the overall project knowledge can gradually be acquired and computed to identify typical or benchmark expectations for each element (score dimension, type of communication, media etc) per unit of cost for each type of communicatee. Retrospectively assigning scores to past communication projects and analyzing them provides an initial calibration. The hierarchy of communication projects can also be incorporated into an overall and differentiated econometric model as a standard function of the benchmark database by capturing key sales metrics, including sales and market share.

The simplicity of the embodiments of the invention is important for their usability. Their flexibility includes: the ability to tailor language; incorporation of the invention's elements into existing user tools or templates, such as marketing or PR briefing processes, contact management systems, media planning tools and knowledge management systems and databases; ability to add one or more customer dimensions.

The embodiments of the invention also support research design and workflow. The five dimensions of the preferred embodiment can be incorporated into research instruments. Examples of these applications include: an audit of customer touchpoints and research into the relative priority given by each type of communicatee to the 5 score dimensions at each touchpoint as well as what constitutes full satisfaction; research of overall brand and/or product/service experience using the 5 dimensions; benchmarking against competitive brands/products; pre-testing of communication; post-communication research design; usages and attitudes brand tracking design; library cataloguing of research projects using the 5 dimensions key.

Embodiments of the invention can also be used in the overall design of products, services, websites and the like. They can also be used to design employee intervention processes such as workshops, employee change programs, etc.

In summary, therefore, in the preferred embodiment of the invention five dimensions have been recognized that apply universally to all marketing, commercial, business and organizational communication, and which may also be used in the design of any elements of an organization that communicates with its stakeholders, audiences, publics or other groups or individuals. These five dimensions are used to score relative and overall priorities, specify the way those priorities should be met. A variety of offline and online user interfaces may be deployed with any useful information technology devices. A multiple element communication project therefore consists of a hierarchy of plan scores with each sub-element contributing to the overall objectives. The tool is incorporated into software systems and stored in benchmark, econometric and knowledge management databases. The five dimensions drive research, planning, evaluation and learning workflow and systems.

The preferred embodiment of the invention provides a system that enables a universal prioritization, planning, specification and evaluation system for any and all types of business, commercial, organizational and political communication, of any type and complexity capable of being embodied in a wide variety of user interfaces and systems.

The five dimensions represent meaningful, authoritative and useful planning dimensions capable of being incorporated into software and other system tools and offline data collection and discussion tools.

A wide variety of applications are supported.

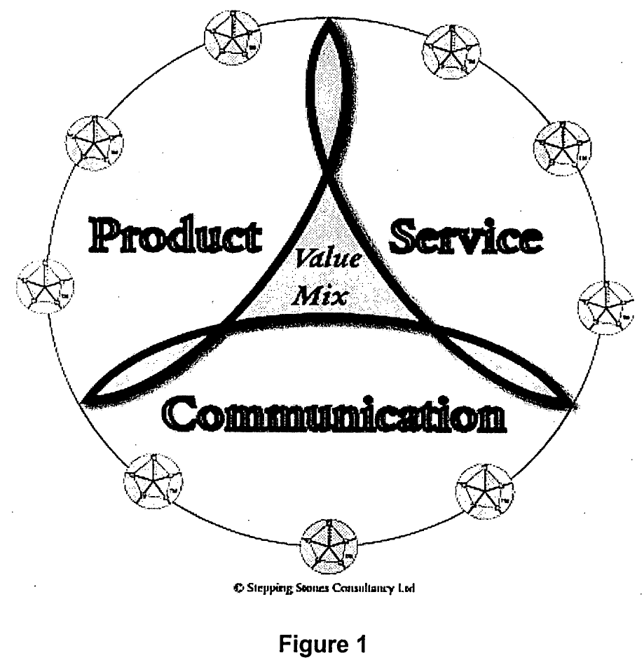

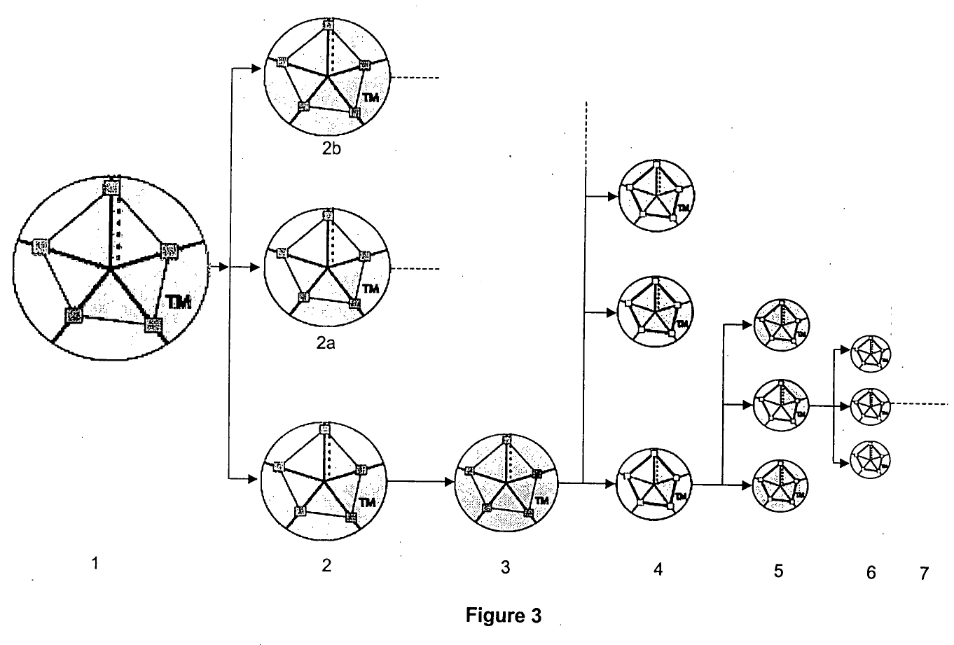

FIG. 1 demonstrates the scope of the communication planning mix and the underlying concept of communication. Communication is seen as a value-generating activity, when effective and is capable of being executed through ‘products’ (tangible goods for sale), ‘services’ (intangible goods for sale) and ‘communication’ (relational exchange through artifacts, communication media and people). For example, ‘products’ communicate through their design and function, saying ‘I am a quality/cheap/stylish . . . product’. The Figure symbolically indicates a series of interactions (‘touchpoints’) between consumers and the product, service and communication elements. The invention can, and in best practice should, be applied to the full range of product, service and communication options from the perspective: what are our communication options? Thus the tool can be applied to the design planning process of a product or service to identify desired communication effects whether these communications effects are explicit (e.g. a user manual or a person speaking) or implicit (e.g. the ‘design statement’). The planning process is described in more detail in FIG. 3. Briefly it comprises identifying touchpoints and determining the communication objectives/priorities for each. Furthermore, the tool can be used throughout the product/service/communication hierarchy: i.e. from the macro level concept to micro level detail. It therefore operates as a fractal tool. (See also FIG. 3).

The tool provides therefore the capability of aiding the design of all aspects of the value-mix. This represents a significant improvement over prior art. Prior art does not take a holistic and fully inclusive approach to value-design and does not have fractal tools to assist this.

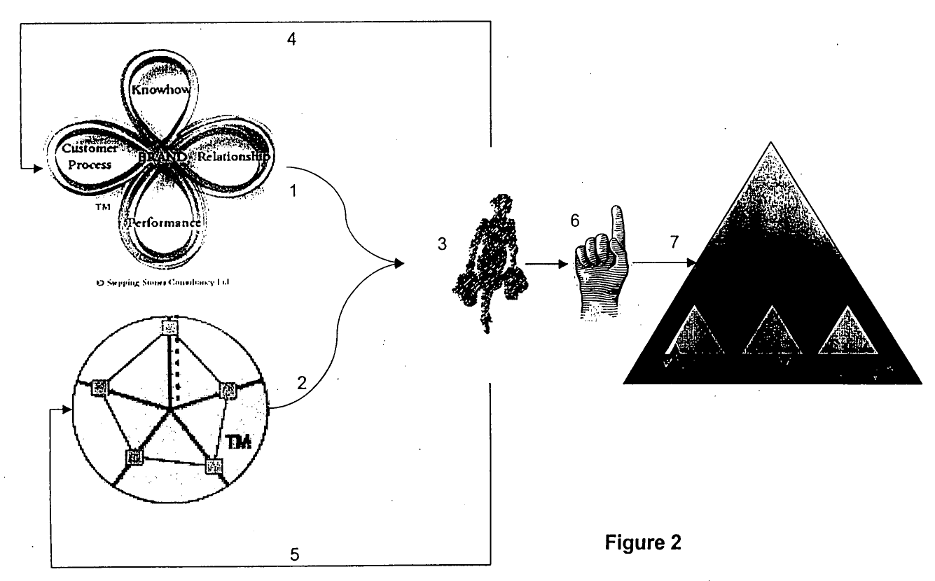

FIG. 2 (Strategic value positioning) represents the tool being used in partnership with a value-design tool, together covering the key elements of the strategic value positioning process. In principle the invention can be used with any fractal value-design tool, but the Stepping Stones Consultancy Ltd ‘Clover Leaf™’ tool is a preferred partner because of its synergy.

Organizations (including commercial firms and brands, NGOs and governmental) provide value to consumers and other organizations (3). The development of a distinctive value concept is known as positioning. In many cases they need both to provide distinctive value (1) and to stimulate demand for it (2) in order to be successful. Strategic value positioning is the process of defining these two elements as a whole. The strategic value positioning represents a claim to exclusive value for the consumer or community of interest by the organization/brand. The invention provides an improvement over prior art through three facets of its operation:
(a) Seamless design of communication value from strategic positioning to detail (see FIG. 3) and inclusion of this in the positioning model;
(b) Comprehensive representation of the elements of communication value across product-service-communication;
(c) Application of a dynamic ‘demand-delivery’ positioning design model

As such, the tool provides support for achieving an existing aspiration of marketers and other leaders: to be able to communicate a distinctive demand-generating value—expectation to desired audiences reflecting delivery capability. This represents an advance over prior art in as much as previous positioning strategy was unable to include strategic communication objectives with associated universal and fractal applications. This therefore also represents a significant advance in the art of strategy.

The cyclic processes to follow in achieving this are:
Develop unique value delivery master proposition using fractal model, such as Clover Leaf (1)
Develop communication master proposition: a unique set of beliefs, feelings, relationship affinity, familiarity, demand and experience objectives that will influence all subsequent communication objectives (2)
Unite these in a single strategic value positioning statement and test (e.g. through research/action research (execution experiment). (Research may also be the start of the process) (3)
Transfer insights to the value-design process for re-modelling (4)
Transfer insights to the communication design process for re-modelling (5)
Develop dynamic dialogue between ‘value-delivery’ and ‘demand-generating-communication’ design activities, leading to repetition of 1 to 5 until a stable unified position is achieved (6).

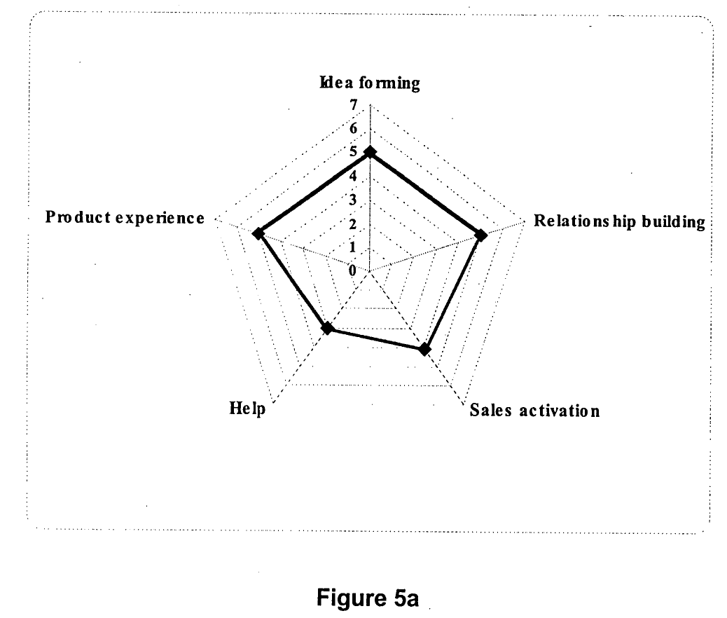

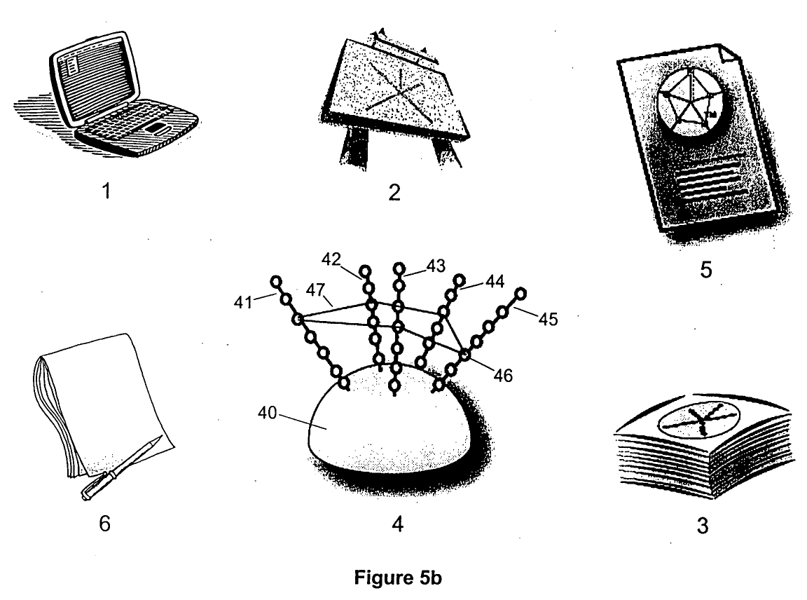

The key strategic applications (7) of strategic value positioning include:
1. Organisation structuring and development. The macro ‘CODAR signature’ (see FIG. 5a) determines priorities for organisation structure, core competence development, infrastructure, process development, R&D and brand management.
2. Functional and process design at unit level. For example different units addressing different markets should be structured, directed, resourced and operated based on their ‘CODAR signature’.
3. Brand management: the brand identity is a function of the strategic value proposition/CODAR signature at both input and output levels given its systemic relationship.

FIG. 3 (Fractal applications) demonstrates the range of applications of the invention, from strategic to atomic detail. Contrasting with the diverse forms of planning and evaluation instruments representing prior art, this represents a significant advance.
Level 1 represents the strategic value positioning (FIG. 2).
Level 2 represents the product-service-communication value-mix (FIG. 1).
Level 3 represents the governing principles for a communication campaign, programme or project. This might be a seasonal project representing a set of co-ordinated activities, a new product launch, the governing idea and principles for the brand for the short to medium term or other similar circumstances.
Level 4 represents channel planning, establishing the priority-mix objectives for say TV advertising, website, sales force, direct mail, retail stores or other primary communication channels for a community or audience.
Level 5 represents communication element planning, for example priority-mix objectives for the home page of a website, a television advertisement, or a telephone script for a call centre.
Where appropriate, Level 6 represents sub-element planning, for example a banner on the home page, a branch in a call script, a promotional deliverable/‘leave-behind’ for a sales call, etc.

Other levels of intermediate or lower detail are conceivably possible. However this structure enables any organization to create a framework of planning levels and to specify the level for planning, communication, evaluation, modeling and comparative benchmarking for example analyzing the relevant effectiveness of contribution of a banner and a brochure to overall objections.

The same structure can also be used for designing the communication elements of ‘product’ (2a) and ‘service’ (2b): for example the objectives for the overall design of an automobile instrumentation panel and computer; or the pre-flight process, check-in process and boarding card in a flight service. In each case the planned priorities and actual customer evaluation represent the ‘CODAR signature’, an innovation in communication art.

Where appropriate, specify further research to support communication planning, e.g. with specific communities or about specific issues.

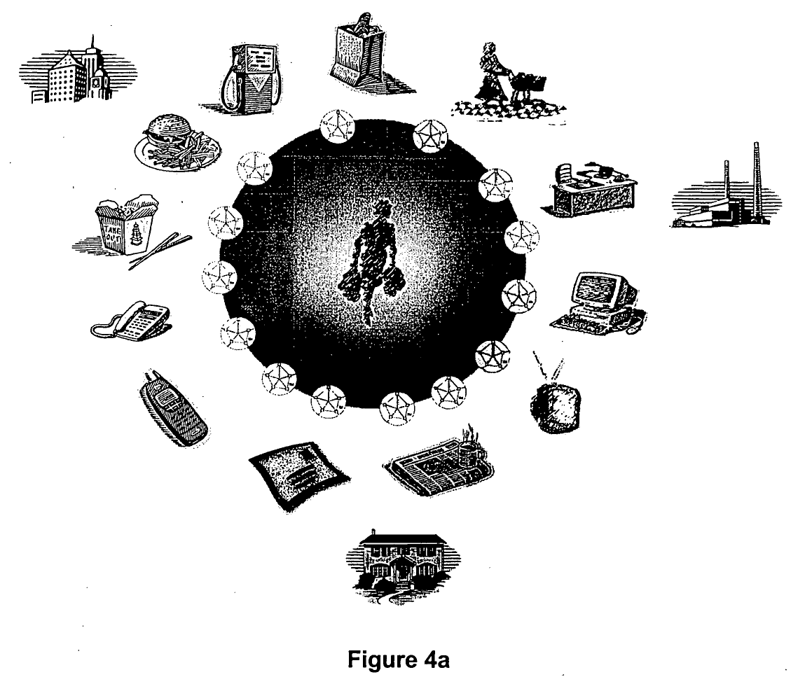

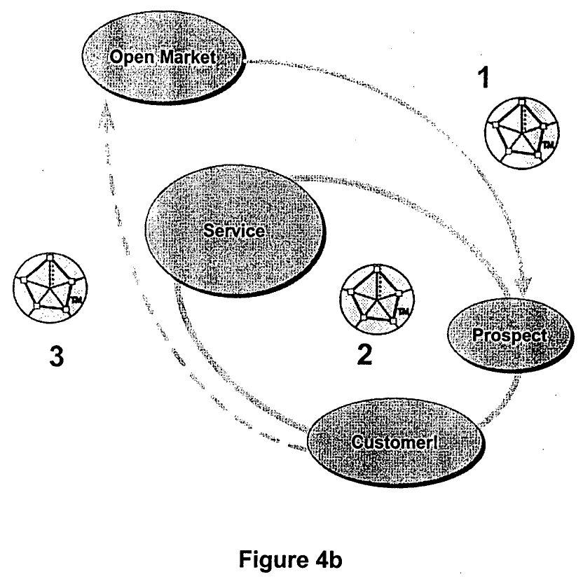

FIG. 4a (Planning by touchpoint) represents the pre-planning and priority-mix planning process for customer relationship management (CRM). Prior art already recognizes the importance of touchpoint planning, i.e. identifying for each stakeholder community the range of interactions that constitute mutually desirable management of the relationship across the spectrum of media and life-style/business behavior. Thus the diagram indicates a range of opportunities for a brand to interact with a customer, employee or shareholder through experiences in the home, office and/or city/town involving diverse media, including goods, shopping and service experiences, TV, SMS, mail, press, internet, email etc. In addition there is a time element:
Times of the day, week, year
Stages in the relationship
Changing circumstances in the communication recipient.

The brand and/or its agencies, including media agencies, can build up a body of quantified knowledge about the relative performance and costs of each touchpoint by customer type and use this for media/touchpoint planning. The embodiments of the invention provide a way to enhance this knowledge across all kinds of touchpoints to inform planning.

FIG. 4b (Planning by relationship stage) represents planning through such changing stages and circumstances, another accepted prior art good practice. However, prior art does not have a universal communication-planning tool.

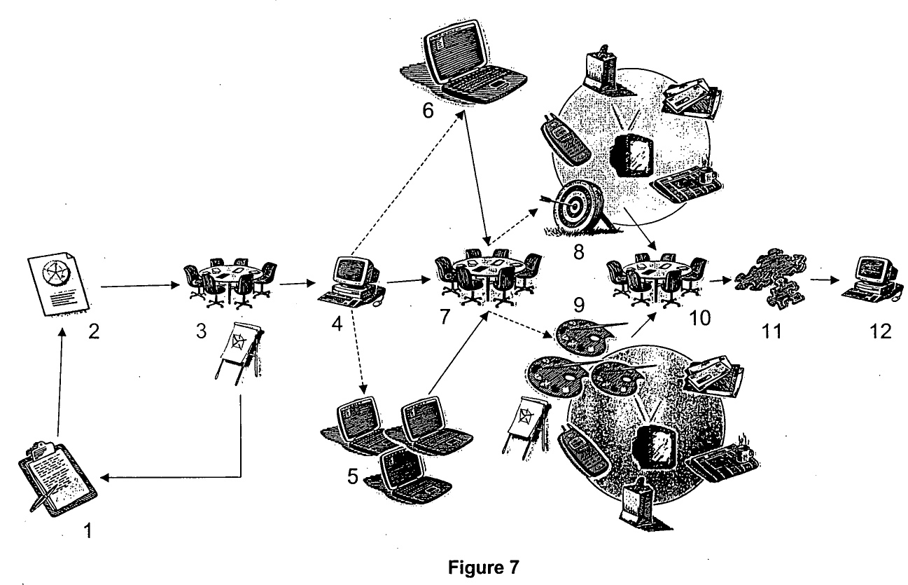

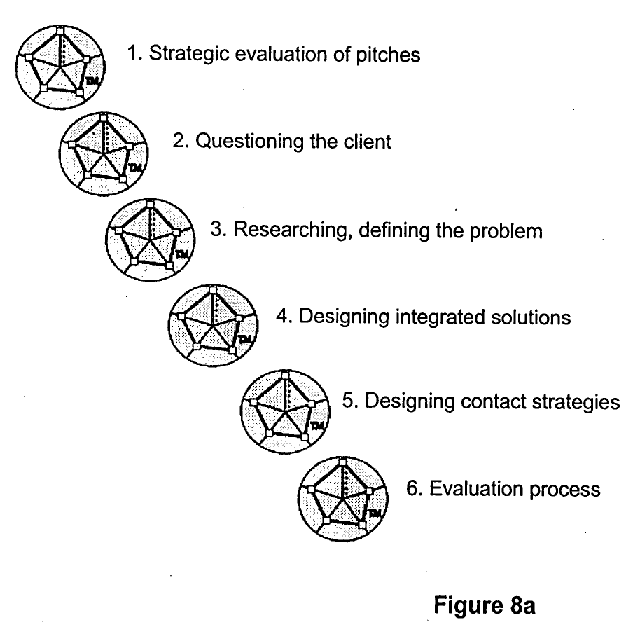

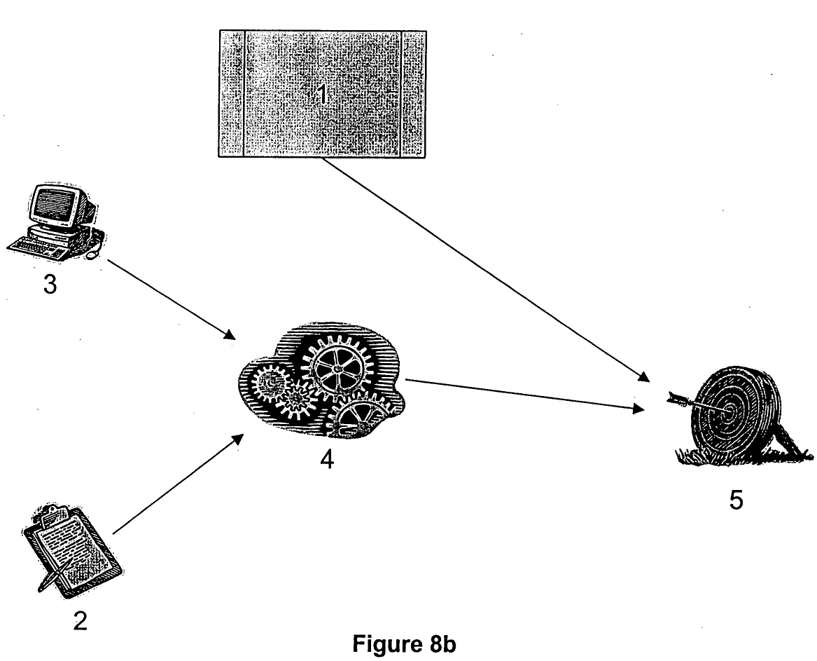

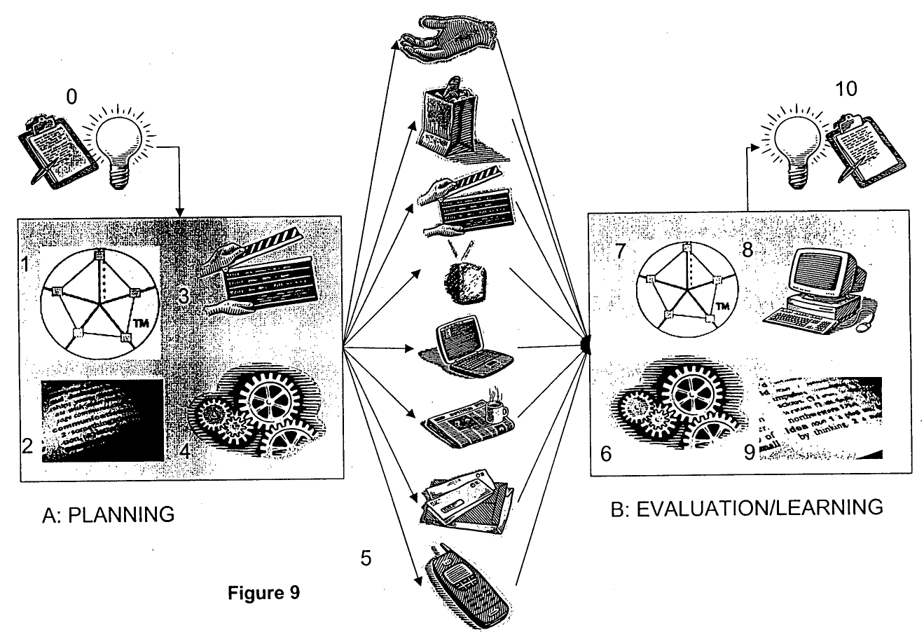

In the case of both 4a and 4b, where 4b represents a more specific articulation of the general possibilities for relationship and communications, there are two recommended stages in the planning process:
1. Identify touchpoints or contact points (commonly known as touchpoint mapping or 360 degree planning), identifying distinguishing features such time, preferences, media, trigger. Best practice uses a planning tool for this, such as the TP Mapping tool from Stepping Stones Consultancy Ltd. Use the invention to design research into communicatee preferences and experiences (see also FIGS. 7 and 9).
2. Apply the invention to determining the communication objectives for the touchpoint (see also FIGS. 7 and 8).

FIG. 5a (Planning/reporting using the CODAR visual), identifies the 5 elements of the planning mix and applies it using a conventional CODAR (or “radar”) chart. The resulting ‘CODAR signature’ of a brand can be both planned and researched. Similarly the CODAR signature for any communication event is determined by this visual, an innovation for marketers and leaders. Best practice adoption of this tool uses a variety of online and offline devices to discuss and form agreements on priority-mix objectives based on research, experience and challenge(s). The variety of online and offline options is a useful convenience.

FIG. 5b (Examples of planning tools) shows examples of these devices including:—
Spreadsheet and graphical software in a computer (1)
Pre-printed Post-It-Notes (3)
A mechanical desk-top executive planner (4)
Pre-printed pads (5)
Blank paper (6)
Briefing template(s) (7)

Pre-printed paper versions (3 and 5) include 5 radial arms labeled with the invention's dimensions and priority marker points for reference.

The mechanical desk-top device (4) consists of a base mount (40) with five radial arms (41, 42, 43, 44, 45), both in any suitable material, such as aluminum, each with a moveable ball (e.g. 46) that clicks into place at one of 7 levels (or as otherwise specified), along the arm and a rubber band (47) that connects the balls. Thus by moving the balls the effect of a 2D CODAR chart is translated into a 3D mechanical device. This item is used in a variety of ways, specifically as a device to promote discussion and dialogue in a group. It may also be used as a promotional device by agencies for their clients.

Best practice in using the CODAR visual device in briefing communication involves the following steps:
1. Determine the corporate standard for the number of priority levels. 7 is the recommended default.
2. Determine the corporate standard for the maximum total. 22 is the recommended default.
3. Decide whether to enable flexing of the available total by the budget size. The default is ‘No’.
4. Train users. A train the trainers programme with reinforcement and real examples is recommended.
5. Use, practise and review using only the Priority, Numeric and Semantic levels (see FIG. 9).
6. Add additional functions as later described (FIG. 9).

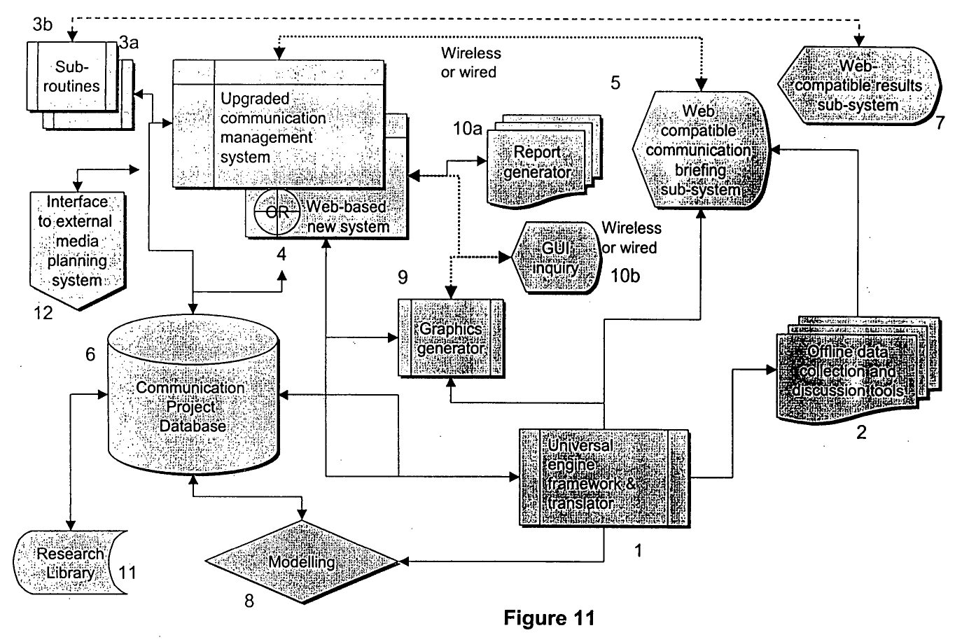

For global organizations, test markets are encouraged to develop and pilot use of the entire system (FIG. 11) while other units initially use only some or all of the planning activities (FIG. 7).

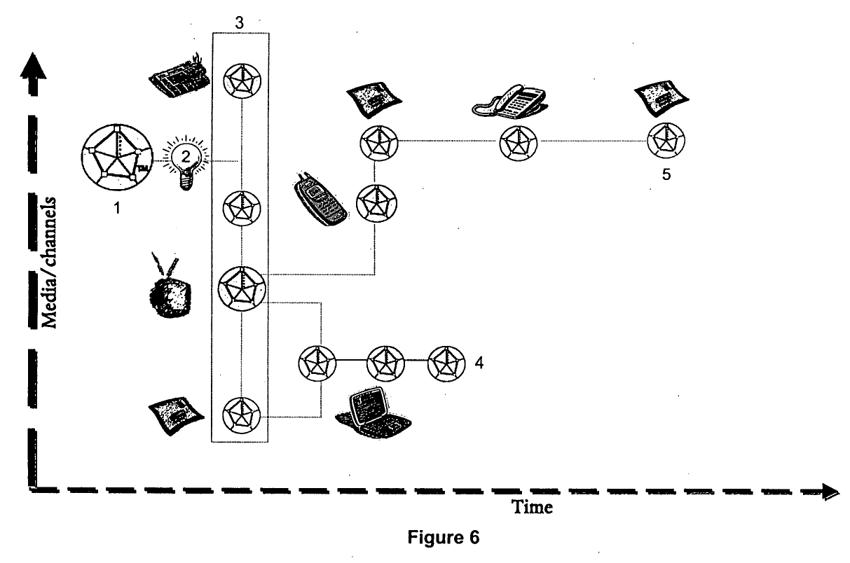

FIG. 6 (Rollout plan) indicates how the tool can be used to design a small, medium or large scale integrated marketing communications plans using the fractal application (FIG. 3):
An overall plan is required that specifies the comprehensive objectives for the entire project (1).
This includes the governing creative idea for the entire project (Idea Forming dimension), but also the governing ideas or principles for all 5 dimensions (2).
Specify the governing principles for a series of communication sub-project areas (3). These may be based on different agency responsibilities, different disciplines (direct, advertising), different customer communities, different media or other useful types. Optimise the mix using media planning tools based on the invention and the knowledge repository (see also FIG. 9).
Within each project area, define the series of activities to be performed, including any interconnecting (networked) activities (e.g. TV ‘drive to web’) (4) and contact strategies (a current art activity) (5). Optimise the choice and method using the knowledge repository (see also FIG. 9).

The advantage of the invention over prior art is once again that it enables a complete set of complex activities to be planned and evaluated using a common standard.

FIG. 7 (Planning process) outlines the preferred planning process for the communication manager (e.g. brand manager).
1. Research forms the input into the process. The preferred research method is to brief research objectives using the invention methodology.
2. Offline discussion of project objectives and individual thinking by the manager.
3. Group discussion by a steering group (that includes six skill elements: customer insight, brand insight, communication know-how, media/channel know-how, social and facilitation skills, project management skills) to agree the brief, using offline tools (e.g. flip chart).
4. Detailed specification of the brief using a format similar to the Communications Neutral Master Brief
5. Communication by email or web-based share system of the brief with all agencies (including internal agencies), specifying requests for solution(s) concepts and solution(s) input.
6. Communication in similar mode with the media agency requesting solution(s) at a strategic advice level.
7. Joint planning meeting (supported by conference calls where appropriate) to discuss proposals and agree a plan. Steps 4 to 7, indeed 1 to 7 can be repeated where necessary.
8. Update system and commission media agency(s) to produce detailed specification. Media planning can benefit from CODAR by adding the CODAR numeric parameters to its own media planning parameters, thus enabling a direct link between CODAR's communication planning and evaluation methodology and the existing media/touchpoint planning and evaluation methodology with an enhancement over prior art due to the ability to score media/touchpoints based on research and analysis of past results.
9. Commission agencies to produce detailed execution level solutions.
10. In one or more meetings review and agree the plan elements with system and offline support.
11. Integrate all elements of the plan into the master schedule.
12. Update the system knowledge repository to provide the basis for evaluation and project management (see also FIG. 9). Reflect any changes in plan. Use project management skills and techniques to manage execution of the plan.

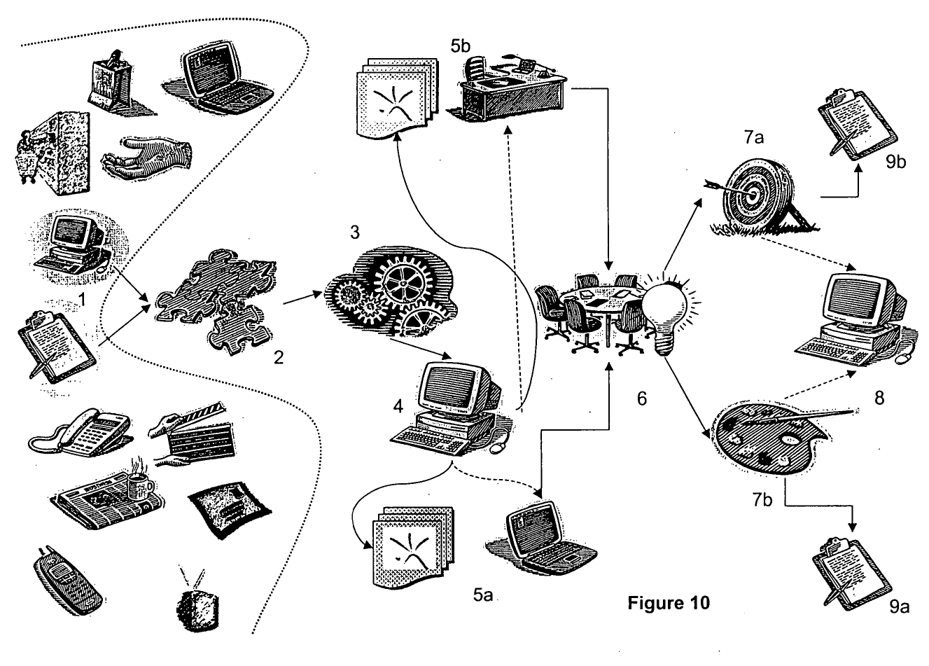

FIG. 8a (How an agency uses the tool) indicates the six recommended steps for an advertising, PR or other agency to use the tool to gain competitive advantage. This represents a complementary process to FIG. 7.
1. During ‘pitches’ for new clients or new projects, use the planning element to refine understanding of the brief and any initial background research.
2. Use the tool in discussion with the client in order to refine understanding of the problem and the brief and/or to test the client's assumptions and thinking.
3. Use this information and the tool to commission research into the brand or corporate situation.
4. Design as complex an integration solution as is required and within capability and budget using the tool (as indicated in FIG. 6). If necessary/appropriate partner with other agencies/groups.
5. As a sub-section of 4 above, design ‘contact strategies’, i.e. a series of interconnected communications based on trigger events (e.g. a response to a particular communication (see FIG. 6).
6. Use to support evaluation of work with the individual client and across clients as indicated in FIGS. 9 and 10. Store results in a knowledge repository based on the tool's architecture, enabling, for example, cross-client benchmarking.

FIG. 8b (How a media/discipline planner uses the tool) indicates recommended methods for the planner including research activities, complementing and further detailing aspects of FIG. 7.

The method builds on prior art techniques in media, discipline and/or channel planning (1) such as demographic and lifestyle associations with media, contact scoring for attractiveness, importance and informativeness, and media and discipline weighting for cost, reach, and communication characteristics. In addition the invention enables the addition of further scores based on research (2) and statistical results or previous communication (3).

Research (2) enables scoring for communicatee preferences, associations and brand associations based on qualitative and quantitative techniques applying questions such as (but not limited to):
What kind of help do you need?
What is the best way for you to get this?
How do brands (or other entities) currently give you this?
Which brands are best at helping?
What is it about their methods that works best?

Results (3) enables scoring based on actual performance of entities.

A model of entities (4) is then developed that weights them according to their relative performance characteristics on the invention's planning dimensions. This model can be progressively refined.

The model is then applied as an additional factor into the media, touchpoint and discipline analytics (5) to weight choice and mix.

FIG. 9 (Universal engine) provides a schematic of the core system that underpins the invention. This provides a layered method of defining and coding all communication activities during the planning phase (A) followed by a reverse process during evaluation (B). This is described in steps 1-10 which outlines use of the NUMERIC-SEMANTIC-TRANSLATOR architecture. The preliminary steps to these activities include prior research and learning, revisited over time as (10).
1. Macro and micro level planning using the fractal concept of all communication activities indicating the NUMERIC component of the priority-mix and objectives for each communication activity.
2. Specify the SEMANTIC component of the objectives for each communication activity. This is a verbal specification of the objective. Where necessary specify multiple semantic objectives. An example of a semantic objective is: “commitment to buy”.
3. Specify the ACTIVITY characteristics of the plan. Recommended elements are:
   a. Description of the activity
   b. Primary method (e.g. direct marketing)
   c. Medium or media mix formats
   d. Budget (and later actual) costs
   e. Audience specification (use standard codes where possible)
   f. Start and finish dates and other schedule specification
   g. Responsible agency
   h. Contact person(s) and details
   i. Attachment of ‘brief’ and ‘creative’ files
4. Specify the TRANSLATOR elements:
   a. Type of evaluation for each objective/sub-objective (e.g. ‘awareness’, ‘affinity score’, ‘conviction’, ‘lead’, ‘satisfaction’) as specified in 2 above.
   b. Quantity that represents 100% attainments of the objective.
   c. Type of unit of measure (e.g. absolute score, increase in score, percentage)
   d. Percentage of overall NUMERIC objective assigned to this sub-objective (where more than one sub-objective exists)
5. Execute the programme through all media/methods applying optimisation principles based on knowledge and experience, and/or findings from third party media and contact analysis and/or findings and rules derived from previous analysis and econometrics from the CODAR database and CODAR research.
6. Evaluate the programme by feeding results back into the system using the TRANSLATOR to calculate NUMERIC attainment.
7. Produce base results
8. Update the corporate benchmark database and compare against other results and/or model relationships between elements using econometric analysis (e.g. SPSS regression analysis) using the general model relationship: overall [business] performance (e.g. sales or market share)←NUMERIC priorities←ACTIVITY METHODS (media, discipline, type of objective). This should include analysis between objectives, priorities, media, method, agencies, countries, audience type, schedule timing etc.
9. Use action learning and similar post-event ‘soft learning’ techniques such as action learning to identify insights. These should include both use of the tool as well as results. Validate or enhance using research.
10. Document and distribute/store for the future in the knowledge repository.

In the case of hierarchical or multi-level communication projects, i.e. projects involving a cascading series of communication activities, with each activity contributing either to a higher level set of priority objectives or to the master set, then the percentage contribution intended by each activity should be specified during planning. This should then be used during evaluation to calculate achievement. For example, if the CODAR NUMERIC priorities or signature is determined for an overall communication project (A) and the project is to be attained by a series of 3 mailings (B1, B2, B3) with an overall NUMERIC priority signature (B), and a series of 5 press ads (C1, C2, C3, C4, C5) with another overall NUMERIC priority signature (C), then the project might be specified such that B will generate 30% of A, with B1, B2 and B3 each contributing 10%, while C contributes 70% with C1, C2, C3, C4 and C5 each contributing 14%. These ratios would then be used to compute actual performance and contribution factors post-communication.

FIG. 10, Evaluation and Learning Process, represents a recommended process for the evaluation phase of using the tool for a managing unit.
1. Execute the programme
2. Retrieve and merge all results through research and/or corporate systems, upgrading these where necessary. Add estimated performance where necessary and possible.
3. Use the TRANSLATOR to analyse and complete the results (see FIG. 9)
4. Store the results in the corporate database using the UNIVERSAL ENGINE architecture. Further analyse using methodology in FIG. 9, #8
5. Produce hard copy and/or electronic reports for internal (5a) and agency (5b) interested parties.
6. Convene appropriate meeting(s) (using conference call and other e-techniques as necessary and as discussed in FIG. 9, #9) to discuss findings.
7. Derive specific media/touchpoint learning (7a) and creative technique learning (7b) as indicated in FIG. 9 #9.
8. Document both in the tool's knowledge repository.
9. Specify further research to either complete learning (where necessary) or as input into the next phase/programme/ in the creative and/or media-touchpoints fields wherever necessary.

FIG. 11 (System schematic) outlines the architecture of the information system to manage the processes outlined in FIGS. 1-10. The aim of the system is to provide process management and knowledge repository elements to support planning, execution and evaluation phases. This system can be adopted by upgrading an existing planning/evaluation system or by adopting a complete new system. The system can also be supplied as a complete administrative support service.
1. The common standards framework and translator module is based on the fractal concept (FIG. 3) and the universal engine architecture (FIG. 9) and a set of standard codes to define objectives and activities (Method, media, schedule etc as indicated in FIG. 9 and capable of enhancement and refinement over time). This provides the fractal architecture for the entire system, an advance over prior art.
2. Offline and online data collection and discussion modules/tools (see FIG. 5b) are used to collect data and agree plans.
3. (a) Sub-routines capture the data required to drive the planning phase (FIG. 7) and update the knowledge repository (b). These may interface with existing planning and briefing systems or new systems (4). The tool architecture updates prior art through its universal architecture.
   (b) Other sub-routines collect data from results, whether data collected from other customer management and business information systems or research. These use the universal architecture module to update the knowledge-base (6) and communication management system (4), an enhancement over prior art that now produces like-to-like comparison.
4. Users may upgrade their existing customer management system to the invention's specification or adopt a new system based on the invention's architecture. The customer management system should include a range of additional current art applications such as briefing (5), budgetary control, project/process management, research and knowledge management, content library (of communications, briefs, work elements, ‘Brand Bible’ etc) and other current art good practice functions. A preferred system would be web-enabled and designed to allow secure partner participation for co-working and knowledge-sharing. The invention would enhance this system over prior art by enabling more effective cross project comparison because projects and sub-products of different kinds can be compared on a common basis.
5. A (preferably web-compatible) briefing sub-system enables capture of all briefs/plans (i.e. client to agency partner briefs and internal agency ‘creative briefs’). The invention would enhance this subsystem over prior art by enabling all briefs at every level to be based on a common architecture (1 and FIG. 9).
6. The communication project database represents the possibility of a complete knowledge repository of communication activity. Knowledge repositories currently exist but they are not linked by a universal engine architecture. The system therefore enables either upgrades to existing databases or new superior database systems to be created based on this architecture.
7. The (preferably web-compatible) results sub-systems enable data to be collected from research and corporate systems and added via sub-routines module (3b), which use the universal engine module (1) to interpret the results (as described in FIG. 9).
8. Modelling and econometric analysis is one preferred way to exploit the advantage of the tool. A preferred implementation would develop a standard set of macros in SPSS (or similar package) that provide statistical and econometric analysis and benchmarking across all the business and communication dimensions (enabling for example analysis of the comparative impact on profit of direct mail relational strategies in Brazil and a web-page's sales activation strategy in France with the same or different audiences). Historic econometric analysis could show that a type of spend (e.g. TV advertising) had a particular performance index, but there was no analysis of effectiveness based on why it worked, and in particular no way to analyse based on a universal cross-method framework.
9. A graphics generator is needed to reproduce the CODAR visual in the information system.
10. Report generators and online (GUI) enquiries should also be used to exploit the tool. These would enable management and users in the organisation and its partners to access information. The ability to access information based on a common, high quality framework and thus to compare different communication plans and work more meaningfully represents an advance over prior art. In addition to search, browse and report options in prior art, the invention enables:
   Every communication piece to be shown with its CODAR signature (plan/actual)
   Every communication piece to be benchmarked and scored against global, local, media, method, community and other desired classes and combinations of classes (where 100 is the class's mean score).
11. The tool can also be used to reference and collate the research library, since research objectives and findings can be sorted and/or filed by the parameters of the ‘universal engine’.
12. The system should have an interface to a media/touchpoint planning system, whether in-house or provided by an external media planning service. The media/touchpoint planning system should be parameter driven and enable specification of the assumed or researched capabilities and costs of different media and touchpoints to execute communication activities to target audiences, in order to recommend most efficient media-mixes, such methods belonging to prior art. Alternatively and preferably, the media/touchpoint planning system may be enhanced to accept additional specification of media/touchpoints performance and costs using the CODAR NUMERICS parameters, which would constitute an enhancement over prior art. This would mean that the media planning system could produce a recommended mix of media/touchpoints using any existing econometric method that will optimise the CODAR-based communications plan.

In order to understand the effectiveness of each type of medium or Touchpoint and each type of communication in achieving priority objectives, media and method profiles should be progressively calculated for each market and/or stakeholder type as data is accumulated. This is achieved through statistical modeling of the correlation of each type of medium or activity with performance achievement of each of the 5 dimensions across the range of activities.

The embodiments described above represent the best ways known to the applicant of putting the invention into practice. However they are not the only ways in which this can be achieved, and are included by way of example only. Indeed, various modifications and additions may be made to such embodiments without departing from the spirit and scope of the invention.

In summary, a system of communication planning, execution and evaluation by marketers and other change agents has been presented, based on a universal standard and method. The method is effective for all media and communication disciplines and is capable of being executed in a variety of information management formats and included in multiple information systems. It is therefore capable of being a common standard and tool for all business, government and NGO communication projects.

1. A method for quantifying and communicating marketing-related information relating to an entity, comprising:
assigning a score to each of a plurality of pre-determined marketing-related dimensions, each score being out of a pre-determined maximum possible score; and
communicating said scores as a characteristic of said entity.

2. A method as claimed in claim 1, wherein said pre-determined marketing-related dimensions are:
idea forming;
relationship building;
behaviour activation;
help or support; and
product or service or environment experience.

3. A method as claimed in claim 1, wherein the total of said scores is limited so as not to exceed a pre-determined maximum possible total.

4. A method as claimed in claim 3 comprising five pre-determined dimensions, wherein each dimension is assigned a score out of seven, and wherein the pre-determined maximum possible total is 22.

5. A method as claimed claim 1, further comprising representing each of said scores visually.

6. A method as claimed in claim 5, further comprising plotting said scores in a radar chart format.

7. A method as claimed in claim 6, further comprising plotting said scores on paper pre-printed with radial arms labelled with said pre-determined dimensions, the radial arms incorporating marker points indicating positions at which possible scores may be represented.

8. A method as claimed in claim 5, further comprising representing said scores by positioning marker elements on a mechanical device, the mechanical device comprising: a base element; a plurality of radial arms protruding from the base element, each radial arm corresponding to one of the said dimensions; and a marker element on each radial arm, each marker element being positionable in any of a plurality of positions on its radial arm, said positions corresponding to possible scores for the corresponding dimension.

9. A method as claimed in claim 1, further comprising:
assigning planned or target scores to each dimension; and
subsequently determining actual scores for each dimension, thereby enabling comparison of the target and actual scores.

10. A method as claimed in claim 1, further comprising entering the scores into a computer.

11. A method as claimed in claim 1, wherein said scores correspond with measurable objectives or achievements for said entity.

12. A method as claimed in claim 1, further comprising retrospectively assigning scores to past communication projects and analysing them to calibrate said method.

13. A method as claimed in claim 1, wherein the method is performed for a plurality of entities within an overall entity.

14. A method as claimed in claim 1, further comprising:
identifying touchpoints at which a consumer interacts with the entity's product, service or communication elements; and
applying the method to those touchpoints.

15. A method as claimed in claim 1, further comprising recording data of a type selected from a group comprising:
verbal description of the objectives;
verbal reasons for the objectives;
one or more numerical or quantitative objectives or one or more weighted objectives that represents full attainment of one or more planned or target scores;
actual quantitative achievement(s);
final result scores;
budget allocations;
actual costs;
the cost per score point;
indices of efficiency against a benchmark database;
verbal analysis of the reasons for the result;
codification of the reasons using standard codes;
learning points.

16. A method as claimed in claim 1, adapted for use in an application selected from a group comprising:
an audit of customer touchpoints and research into the relative priority given by each type of communicatee to the score dimensions at each touchpoint;
what constitutes full satisfaction;
research of overall brand and/or product/service experience using the plurality of dimensions;
benchmarking against competitive brands/products;
pre-testing of communication;
post-communication research design;
usages and attitudes brand tracking design;
library cataloguing of research projects using the plurality of dimensions.

17. A device for visualising scores assigned to each of a plurality of marketing-related dimensions, said device comprising:
a base element;
a plurality of radial arms protruding from the base element, each radial arm corresponding to one of the said marketing-related dimensions; and
a marker element on each radial arm, each marker element being positionable in any of a plurality of positions on its radial arm, said positions corresponding to possible scores for the corresponding marketing-related dimension.

18. A device as claimed in claim 17, wherein the radial arms are configured with means by which to retain the marker elements in the said plurality of positions.

19. A device as claimed in claim 17, wherein the marker elements are connected by a rubber band.

20. A device as claimed in claim 17, wherein the marker elements are in the form of balls.

21. A printed article for visualising scores assigned to each of a plurality of marketing-related dimensions, said article comprising a surface pre-printed with radial arms labelled with said dimensions, the radial arms incorporating marker points indicating positions at which possible scores may be represented.

22. A printed article as claimed in claim 21, being selected from a group comprising:
pre-printed post-it notes;
pre-printed paper

23. Apparatus for quantifying and communicating marketing-related information relating to an entity, said apparatus comprising:
an input device operable to receive a plurality of scores, each score being out of a pre-determined maximum possible score;
a processor operable to assign each score to a corresponding one of a plurality of pre-determined marketing-related dimensions; and
an output device operable to communicate said scores as a characteristic of said entity.

24. Apparatus as claimed in claim 23, wherein the output device is arranged to display the scores in the form of a radar chart.

25. A computer programmed for use in quantifying and communicating marketing-related information relating to an entity, said computer being programmed to:
receive a plurality of scores, each score being out of a pre-determined maximum possible score;
assign each score to a corresponding one of a plurality of pre-determined marketing-related dimensions; and
output said scores as a characteristic of said entity.

26. A computer as claimed in claim 25, further programmed to display the scores in the form of a radar chart.

27. A computer program executable to enable a computer to receive and communicate marketing-related information relating to an entity, said computer program enabling the computer to:
receive a plurality of scores, each score being out of a pre-determined maximum possible score;
assign each score to a corresponding one of a plurality of pre-determined marketing-related dimensions; and
output said scores as a characteristic of said entity.

28. A computer program as claimed in claim 27, configured to display the scores in the form of a radar chart.

29. A computer program stored on a data carrier, said computer program being executable to enable a computer to receive and communicate marketing-related information relating to an entity, said computer program enabling the computer to:
receive a plurality of scores, each score being out of a pre-determined maximum possible score;
assign each score to a corresponding one of a plurality of pre-determined marketing-related dimensions; and
output said scores as a characteristic of said entity.
